(19) United States
(12) Patent Application Publication
(10) Pub. No.: US 2022/0045567 A1
(43) Pub. Date: Feb. 10, 2022

(54) Cavity Structure for Permanently Excited Electric Machines With Embedded Magnets

(71) Applicant: Bayerische Motoren Werke Aktiengesellschaft, Muenchen (DE)

(72) Inventors: Norman BORCHARDT, Oberschleissheim (DE); Korbinian KOENIG-PETERMAIER, Muenchen (DE)

(21) Appl. No.: 17/414,000

(22) PCT Filed: Jan. 21, 2020
(86) PCT No.: PCT/EP2020/051349

§ 371 Date: Jun. 15, 2021

(30) Foreign Application Priority Data
Feb. 19, 2019 (DE) 10 2019 104 072.8

(51) Int. Cl. H02K 1/27; H02K 15/03

(52) U.S. Cl. CPC H02K 1/2766; H02K 15/03

(57) ABSTRACT

A rotor includes at least two rotor poles, a rotor iron core which has at least one cavity per rotor pole, wherein webs are formed between the cavities and the exterior of the rotor iron core in the radial direction and an embedded permanent magnet assembly for generating a magnetic air gap flux density, the assembly having at least one permanent magnet per rotor pole in the respective cavity. In order to influence the curve of the magnetic air gap flux density, magnetic flux blocking sections and magnetic flux conducting sections are arranged in an alternating manner in the at least one web of each rotor pole along the circumferential direction, wherein the magnetic flux blocking sections are designed to conduct a magnetic flux within the adjacent magnetic flux conducting section and have different geometries in the circumferential direction starting from a rotor pole center to rotor pole edges.

### BACKGROUND AND SUMMARY OF THE INVENTION

The invention relates to a rotor for a permanently excited electric machine, the rotor having at least two rotor poles that are arranged adjacent to one another in the circumferential direction of the rotor. The rotor comprises a rotor iron core which comprises for each rotor pole at least one hollow space that extends in an axial manner through the rotor iron core, wherein respective webs that extend in the circumferential direction are formed in the radial direction between the hollow spaces and an outer face of the rotor iron core. Furthermore, the rotor comprises a permanent magnet arrangement that is embedded in the rotor iron core so as to generate an air gap magnetic flux density in an air gap of the electric machine, the air gap being radially adjacent to the outer face of the rotor iron core. The permanent magnet arrangement comprises for each rotor pole at least one permanent magnet that is arranged in the respective hollow space. The invention relates furthermore to a permanently excited electric machine and to a motor vehicle.

In the present case, permanently excited electric machines for motor vehicles are being discussed. Such machines can be used for example as drive machines for electrically drivable motor vehicles, in other words electric or hybrid vehicles. Permanently excited electric machines comprise an immovably mounted stator having energizable stator windings and also a rotor that is mounted in such a manner as to be able to rotate with respect to the stator and comprises a permanent magnet arrangement. The permanent magnet arrangement can comprise for example surface magnets or permanent magnets that are embedded or hidden and are arranged in the hollow spaces of a rotor iron core of the rotor.

A progression of a magnetic flux density that is generated by the permanent magnets within an air gap between the rotor and the stator influences the behavior, for example a torque and a power loss, of the electric machine. In this case, a sinusoidal progression of the magnetic flux density over an electrical angle is ideal. Successive leakages from the permanent magnet influence the qualitative and quantitative progression of the air gap magnetic flux density. A leakage in the form of a magnetic flux leakage which does not flow through the stator or its winding does not contribute to the formation of the torque and therefore reduces the amplitude and influences the shape of the sinusoidal basic harmonic that forms the net torque. A leakage in the form of a harmonic wave flux leakage superimposes harmonic waves on the sinusoidal basic harmonic that forms the net torque. These harmonic waves are responsible for an additional power loss in the active parts and consequently for an additional warming of the electric machine. Furthermore, the harmonic waves cause additional waviness or unevenness in the torque.

In order for the air gap flux density to form approximately a sinusoidal progression, the publication WO 2012/101083 A2 discloses a permanently excited synchronous machine. The synchronous machine comprises a stator that comprises a winding system which is arranged in grooves of a laminated core of the stator, wherein the grooves face an air gap that is located between the stator and a rotor. The rotor comprises permanent magnets that form an even number of poles, wherein when viewed in the circumferential direction each pole comprises at least three permanent magnets. The radial height and the residual magnetism of the permanent magnets reduces when viewed in the circumferential direction starting from the middle of a pole to the ends of the respective pole and the coercive field strength of the permanent magnets increases starting from the middle of the pole to the ends of the pole. In accordance with the related art, the progression of the air gap flux density is therefore influenced by way of the material and geometry of the permanent magnets.

It is the object of the present invention to provide an alternative solution, in particular a solution that can be realized in a simple manner, so as to influence a progression of an air gap magnetic flux density of a permanently excited electrical machine.

This object is achieved in accordance with the claimed invention.

A rotor in accordance with embodiments of the invention for a permanently excited electric machine comprises at least two rotor poles that are arranged adjacent to one another in the circumferential direction of the rotor. The rotor comprises a rotor iron core that comprises for each rotor pole at least one hollow space that extends in an axial manner through the rotor iron core. Respective webs that extend in the peripheral direction are formed in the radial direction between the hollow spaces and an outer face of the rotor iron core. Furthermore, the rotor comprises a permanent magnet arrangement that is embedded in the rotor iron core so as to generate an air gap magnetic flux density in an air gap of the electric machine, the air gap being adjacent to the outer face of the rotor iron core. The permanent magnet arrangement comprises for each rotor pole at least one permanent magnet that is arranged in the respective hollow space of the rotor pole. So as to influence a progression of the air gap magnetic flux density, magnetic flux blocking sections and magnetic flux conducting sections are arranged in an alternating manner along the circumferential direction in each rotor pole in the at least one associated web. The magnetic flux conducting sections are formed by way of rotor iron core regions. The magnetic flux blocking sections are configured so as to conduct a magnetic flux of the associated permanent magnet within the respective adjacent magnetic flux conducting section and comprise for example different geometries along the circumferential direction starting from a rotor pole middle to the rotor pole edges.

Furthermore, the invention relates to a permanently excited electric machine having a stator and a rotor that is in accordance with the invention and is mounted in such a manner as to be able to rotate with respect to the stator, wherein an air gap is formed between the rotor and the stator. The air gap therefore lies along the radial direction between the rotor and the stator.

The electrical machine can be used for example as an electric traction machine for an electrically drivable motor vehicle. The electric machine comprises the stator which comprises a stator iron core or stator laminated core having grooves that are arranged distributed at equal distance from one another in the circumferential direction. Energizable stator windings are arranged in the grooves that face the air gap between the stator and the rotor. The rotor is mounted in such a manner as to be able to rotate in an interior space that is encompassed by way of the hollow cylindrical stator laminated core. The air gap is formed between an inner face of the stator, which comprises the grooves and faces the interior space, and the outer face of the rotor iron core.

The rotor iron core or the rotor laminated core is in particular likewise formed in a hollow cylindrical manner and comprises an inner face that faces the axis of rotation, and an outer face that faces the air gap. The inner face encompasses a rotor shaft that extends in an axial manner along the axis of rotation and is connected consequently in a non-rotatable manner to the rotor. The rotor comprises at least two rotor poles, wherein each rotor pole is allocated a sector of the rotor iron core. Two adjacent alternating rotor poles in the form of a magnetic south pole and a magnetic north pole form a pole pair. In this case, at least one permanent magnet is arranged in each sector. The permanent magnets are in this case embedded or hidden magnets that are arranged in the hollow spaces of the rotor iron core. It is possible in this case to provide that each rotor pole comprises a hollow space having a permanent magnet. The permanent magnet can in this case also be a divided permanent magnet with the result that two part-permanent magnets are arranged in a hollow space separated for one another by way of an air gap. It also possible to provide that a rotor pole comprises at least two hollow spaces that are adjacent to one another in the circumferential direction wherein a permanent magnet is arranged in each hollow space.

Since the hollow space that extends in an axial manner through the laminated core is completely surrounded in the radial direction and in the circumferential direction by the rotor iron core material, rotor iron core material is located in the radial direction between the hollow space and the outer face of the rotor iron core, which is facing the air gap, and consequently between the permanent magnets, which are arranged in the hollow space, and the air gap. This rotor iron core material forms the webs or bridges that extend in the circumferential direction. The webs therefore lie in the radial direction over the permanent magnets. The magnetic flux is conducted between the permanent magnet and the air gap by way of these webs.

In particular, as a result of high radial magnetic flux densities at the rotor pole edges, harmonic wave flux leakages occur which result in additional losses being generated in the active parts and which influence the progression of the air gap magnetic flux density to the extent that harmonic waves are superimposed on its basic harmonic that generates net torque. The basic harmonic of the air gap magnetic flux density should comprise in particular a sinusoidal progression. In order to reduce these harmonic waves, the at least one web is divided in each rotor pole into magnetic flux conducting sections and magnetic flux blocking sections. The magnetic flux conducting sections and the magnetic flux blocking sections are arranged along the circumferential direction and consequently in an alternating manner along an extension direction of the web. The magnetic flux blocking sections form a magnetic flux blocking structure and the magnetic flux conducting sections form a magnetic flux conducting structure. The magnetic flux blocking sections can be arranged in this case at an equal distance from one another or not at an equal distance from one another. Also, it is possible to arbitrarily select a number and geometry of magnetic flux blocking sections for each rotor pole.

The magnetic flux blocking sections comprise a considerably greater reluctance in comparison to the rotor iron core or a considerably greater magnetic resistance. In this case, the magnetic flux blocking sections function as magnetic resistors that can influence an orientation of the magnetic flux in the adjacent magnetic flux conducting sections and consequently a concentration of the magnetic flux. It is preferred that the magnetic flux blocking sections are magnetically, in particular also electrically, insulating. As a result, the magnetic flux blocking sections act as magnetic barriers in the circumferential direction over their radial length for the magnetic flux that is conducted in the adjacent magnetic flux conducting section. The greater the radial length of the magnetic flux blocking section, the less the magnetic flux is able to spread along the circumferential direction and the stronger the concentration of the magnetic flux is along the radial direction.

So as to form the different geometries, the magnetic flux blocking sections comprise preferably reducing radial lengths along the circumferential direction starting from a rotor pole middle to the rotor pole edges. The rotor pole middle therefore comprises the magnetic flux blocking section or magnetic flux blocking sections having the greatest radial length. The magnetic flux that results in harmonic wave leakage is to be deflected at the rotor pole edges which lie opposite in the circumferential direction and at which the edges of the permanent magnets are located, but along the circumferential direction, and consequently in lieu thereof rotor leakage is to be generated with the result that the magnetic flux blocking sections comprise the smallest radial length. As the length of the magnetic flux blocking sections reduces, the concentration therefore reduces in the radial direction within the adjacent magnetic flux conducting sections and the magnetic flux at the rotor pole edges is intentionally short circuited within the rotor having the respective adjacent rotor poles. In this case, the lengths can reduce uniformly or irregularly in the direction of the rotor pole edges. Each rotor pole can be formed in this case in an axis symmetrical manner or an axis asymmetrical manner with respect to the rotor pole middle. Also, the radial lengths of the magnetic flux blocking sections are less than a radial thickness of the web. The flux blocking sections also do not penetrate the outer face of the rotor iron core.

By virtue of varying the geometry of the magnetic flux blocking sections in the circumferential direction, it is possible to influence the progression of the air gap magnetic flux density. In particular, the progression of the air gap magnetic flux density can be approximately a sine wave. As a result of the reduction of the radial concentration in the direction of the rotor pole edges where the edges of the permanent magnets are usually arranged, it is possible to deflect the magnetic flux which occurs there. It is thus possible for harmonic waves in the progression of the air gap magnetic flux density and consequently losses to be reduced. Furthermore, an amplitude of a basic harmonic of the air gap magnetic flux density progression increases as a result of the increased concentration of the magnetic flux in the radial direction in the rotor pole middle. It is thus possible in an advantageous manner to increase the torque of the electric machine.

In one embodiment of the invention, the permanent magnets are arranged in a V-shaped arrangement. An angle of the V-shaped arranged can be oriented in this case in an arbitrary manner. For example, the permanent magnets can be oriented in a tangential manner with respect to the axis of rotation. In this case, the angle of the V-shaped arrangement is for example 180°. Also, the permanent magnets can be oriented in a radial manner with respect to the axis of rotation. In this case, the angle of the V-shaped arrangement can be for example less than 90°. The magnetization of the permanent magnets is in this case in particular normal with respect to a longitudinal axis of the magnet. In the case of the tangential arrangement of the permanent magnets, the magnetization is therefore oriented essentially in a radial manner with respect to the axis of rotation. In the case of the radial arrangement of the permanent magnets, the magnetization is therefore essentially oriented in a tangential manner with respect to the axis of rotation. By virtue of the tangential arrangement of the permanent magnets oriented along the circumferential direction, a radial width of the webs reduces starting from the rotor pole middle in the direction of the rotor pole edges. The radial width of the web is therefore the smallest at the web edges that are adjacent to the rotor pole edges and the edges of the permanent magnets are arranged adjacent to these web edges. In order in this case to prevent that the magnetic flux that occurs at the edges of the permanent magnets being conducted through the air gap and thus increase the harmonic waves, this magnetic flux is deflected by way of the short magnetic flux blocking sections that are arranged in the vicinity of the rotor pole edges with the result that the harmonic waves are reduced in the progression of the air gap magnetic flux density.

It has shown to be advantageous if the permanent magnets are oriented in a tangential manner with respect to the axis of rotation of the rotor and in this case a surface of the permanent magnets which is facing the outer face of the rotor iron core is arched in a convex manner. The hollow spaces comprise an inner face that is arched in a concave manner and corresponds to the surface that is arched in a convex manner, as a result the associated webs have an essentially constant radial thickness in the circumferential direction. The concave surface of the permanent magnets is arranged in a contiguous manner on the concave inner face of the hollow space. A shape of the web is influenced by way of the concave inner face of the hollow space that extends in particular parallel to the outer face of the rotor iron core. The webs are consequently formed in the shape of an arc and have the constant radial thickness in the circumferential direction. This shape of the permanent magnets has a favorable effect on the sinusoidal shape of the air gap magnetic flux density progression in an advantageous manner, wherein by way of the magnetic flux blocking sections the amplitude of the basic harmonic can be increased and the amplitudes of the harmonic waves can be reduced.

In one advantageous development of the invention, the magnetic flux blocking sections are formed as cavities that extend in the respective web in an axial manner through the rotor iron core. Cavities are hollow spaces or cut-outs that penetrate the rotor iron core at least in part in an axial manner. The web is therefore penetrated along the circumferential direction in sections by cut-outs which are adjoined by web sections of rotor iron core material. The magnetic flux blocking structure is therefore formed as a cavity structure. The web sections of rotor iron material form in this case the magnetic flux conducting sections. It is particularly simple to produce magnetic flux blocking sections in the form of cavities in the rotor iron core. The radial lengths of the cavities are in this case in particular selected so that the outer face of the rotor iron core is not penetrated but rather that the rotor iron core comprises a closed surface. Furthermore, a volume and weight of the rotor iron core are reduced by way of the cavities. As a consequence, it is possible advantageously to save costs.

It can be provided that the cavities are filled with a support material so as to increase a mechanical stability of the rotor. Such a support material can be for example a synthetic material. The support material in this case is in particular magnetically and electrically insulating. It is possible by way of the support material to prevent the rotor iron core from being damaged by the centrifugal force that acts on the rotor iron core sections in the region of the webs as the rotor rotates about the axis of rotation in the radial direction.

The invention also relates to a motor vehicle having a permanently excited electric machine in accordance with the invention. The motor vehicle is in particular an electric or hybrid vehicle and comprises the electric machine as an electric traction machine or drive machine.

The embodiments that are presented with regard to the rotor in accordance with the invention and their advantages apply accordingly for the electric machine in accordance with the invention and for the motor vehicle in accordance with the invention.

Further features of the invention are disclosed in the claims, the figures and the description of the figures. The features and feature combinations mentioned above in the description and the features and feature combinations that are mentioned below in the description of the figures and/or are only illustrated in the figures are not only useable in their respective disclosed combination but rather can also be used in other combinations or as standalone.

The invention is now explained in detail with the aid of a preferred exemplary embodiment and with reference to the drawings.

### BRIEF DESCRIPTION OF THE DRAWINGS

FIG. 1 illustrates a schematic sectional view of a sector of an embodiment of an electric machine.

FIG. 2 illustrates magnetic flux density progressions in the air gap of electric machines in accordance with FIG. 1 and an electric machine in accordance with the related art.

### DETAILED DESCRIPTION OF THE DRAWINGS

Like and like-functioning sections are provided with identical reference numerals in the figures.

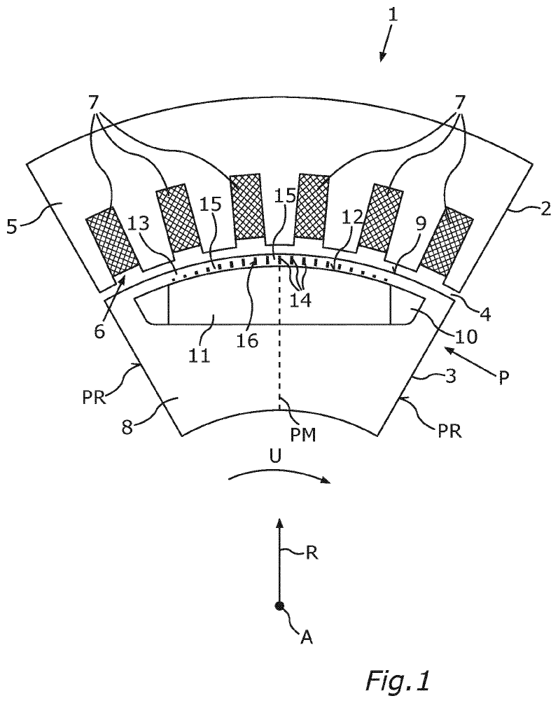

FIG. 1 illustrates a sectional view of a sector of an embodiment of a permanently excited electric machine 1 in accordance with the invention. The electric machine 1 can be formed for example as an electric traction machine of an electrically drivable motor vehicle that is not illustrated here. The electric machine 1 comprises a stator 2 and a rotor 3 that is mounted in such a manner as to be able to rotate with respect to the stator 2 about an axis of rotation A. The stator 2 and the rotor 3 are arranged spaced apart from one another leading to the formation of an air gap 4. The stator 2 comprises a stator laminated core 5 having a multiplicity of grooves 6 which are arranged distributed in the circumferential direction U and in which energizable windings 7 of the stator 2 are arranged so as to generate a rotating field. By virtue of this rotating field, the stator 3 can be excited so as to rotate about the axis of rotation A.

The rotor 3 comprises at least two rotor poles P, wherein in this case for example a rotor pole P is illustrated in the form of a magnetic north pole. A rotor pole P, not illustrated here, in the form of a magnetic south pole follows adjacent to the magnetic north pole. The rotor 3 comprises a rotor iron core 8 or a laminated core that comprises an outer face 9 that faces the air gap 4. Furthermore, each rotor pole P comprises at least one hollow space 10 that extends through the rotor iron core 8 in an axial direction along the axis of rotation A. A permanent magnet 11 is arranged in the hollow space 10 and this permanent magnet forms an embedded permanent magnet arrangement with the permanent magnets 11 of the other rotor poles P of the rotor 3. This embedded permanent magnetic arrangement generates in the air gap 4 a magnetic flux density or air gap flux density, the progression of which influences an operation of the electric machine 1. In particular, the progression of the air gap flux density influences a variable and a torque ripple of the electric machine 1 and power losses of the electric machine 1.

The permanent magnet 11 here is a magnet that is arranged in a tangential manner, extends in the circumferential direction U and has a magnetization that is oriented along the radial direction R. The permanent magnet 11 here comprises in addition a shape which comprises a convex surface 12 that is arched in the direction of the air gap 4. A web 13 is located in the rotor iron core 8 in the radial direction R between the hollow space 10 and the air gap 4. The magnetic flux between the air gap 4 and the permanent magnet 11 is conducted by way of this web 13. In order to influence the progression of the air gap magnetic flux density that results from the magnetic flux of the permanent magnets 11, each rotor pole P comprises magnetic flux blocking sections 14 and magnetic flux conducting sections 15 which are arranged in the web 13 and consequently in the radial direction R over the permanent magnet 11. Starting from a rotor pole middle PM in the direction of the rotor pole edges PR that lie opposite in the circumferential direction U, a concentration of the magnetic flux reduces in the radial direction R by way of the magnetic flux blocking sections 14 and the magnetic flux conducting sections 15 and a leakage of the magnetic flux or a concentration of the magnetic flux increases in the circumferential direction U.

The magnetic flux blocking sections 14 are arranged spaced apart in the circumferential direction U and distributed over a length of the web 13, wherein in each case a magnetic flux conducting section 15 lies between two magnetic flux blocking sections 14. The magnetic flux blocking sections 14 are configured so as to guide the magnetic flux into their adjacent magnetic flux conducting sections 15 of the web 13. The magnetic flux blocking sections 14 are in particular magnetically insulating and consequently form barriers or blocks for the magnetic flux in the circumferential direction U. The magnetic flux is therefore conducted by way of the magnetic flux conducting sections 15 but not by way of the magnetic flux blocking sections 14. The magnetic flux blocking sections 14 can however influence a direction of the magnetic flux in the magnetic flux conducting sections 15.

A barrier effect in the circumferential direction U is in this case greater in the rotor pole middle PM than at the rotor pole edges PR. Consequently, the magnetic flux is concentrated in the rotor pole middle PM in the radial direction R and is conducted in the direction of the air gap 4 by way of the magnetic flux conducting section(s) 15 that are arranged in the rotor pole middle PM. The magnetic flux is purposefully dispersed at the rotor pole edges PR, in other words also deflected in the circumferential direction U. So as to vary this barrier effect in the circumferential direction U, a radial length of the flux blocking sections 14 reduces starting from the rotor pole middle PM in the direction of the rotor pole edges PR. In the present case, the magnetic flux blocking sections 14 are formed as cavities 16 that extend in the axial direction A at least in sections through the rotor iron core 8. The magnetic flux conducting sections 15 are part regions of the rotor iron core 8 within the web 13.

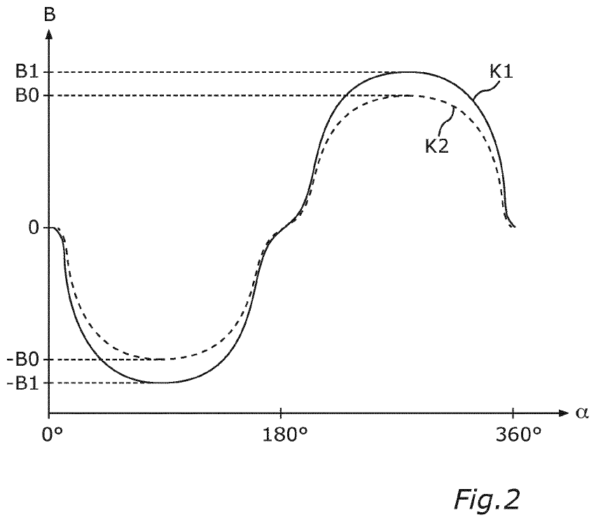

By virtue of the arrangement of magnetic flux blocking sections 14 and magnetic flux conducting sections 15 and by virtue of the shape of the permanent magnets 11, it is possible to realize a sinusoidal air gap magnetic flux density progression with reduced harmonic waves. Such a progression of the air gap magnetic flux density B is plotted in FIG. 2 with reference to the characteristic curve K1 in a qualitative manner over the electrical angle α over two adjacent rotor poles P. In comparison thereto, a characteristic curve K2 of a flux density progression for a conventional rotor without magnetic flux blocking sections and magnetic flux conducting sections is plotted in a qualitative manner. Furthermore, by virtue of the magnetic flux blocking sections 14 and magnetic flux conducting sections 15 and their concentration effect in the rotor pole middle PM, an amplitude B1 of the rotor 3 in accordance with embodiments of the invention is increased in comparison to an amplitude B0 of the conventional rotor. This increased amplitude B1 results in a higher torque of the electric machine 1.

### LIST OF REFERENCE NUMERALS

1 Electric machine
2 Stator
3 Rotor
4 Air gap
5 Stator laminated core
6 Grooves
7 Windings
8 Rotor iron core
9 Outer face
10 Hollow space
11 Permanent magnet
12 Surface
13 Web
14 Magnetic flux blocking sections
15 Magnetic flux conducting sections
R Radial direction
U Circumferential direction
A Axis of rotation
P Rotor poles
PM Rotor pole middle
PR Rotor pole edges
K1, K2 Characteristic curves
B Magnetic flux density
α Angle

1-9. (canceled)

10. A rotor for a permanently excited electric machine, the rotor comprising:
at least two rotor poles that are arranged adjacent to one another in a circumferential direction;
a rotor iron core comprising for each rotor pole, at least one hollow space that extends in an axial manner through the rotor iron core, wherein respective webs that extend in the circumferential direction are formed in a radial direction between the at least one hollow space and an outer face of the rotor iron core; and
a permanent magnet arrangement that is embedded in the rotor iron core so as to generate an air gap magnetic flux density in an air gap of the electric machine, the air gap being adjacent to the outer face of the rotor iron core, wherein:
the permanent magnet arrangement comprises, for each rotor pole, at least one permanent magnet that is arranged in a respective hollow space,
so as to influence a progression of an air gap magnetic flux density, magnetic flux blocking sections and magnetic flux conducting sections are arranged in an alternating manner along the circumferential direction in at least one web of each rotor pole,
the magnetic flux conducting sections are formed by rotor iron core regions, and
the magnetic flux blocking sections are configured so as to conduct a magnetic flux of an associated permanent magnet within a respective adjacent magnetic flux conducting section and comprise different geometries along the circumferential direction starting from a rotor pole middle to rotor pole edges.

11. The rotor according to claim 10, wherein so as to form the different geometries, the magnetic flux blocking sections comprise reducing radial lengths along the circumferential direction starting from the rotor pole middle to the rotor pole edges.

12. The rotor according to claim 10, wherein the permanent magnets are arranged in a V-shaped arrangement.

13. The rotor according to claim 12, wherein:
the permanent magnets are oriented in a tangential manner with respect to an axis of rotation of the rotor, and
a surface of the permanent magnets that is facing the outer face of the rotor iron core is arched in a convex manner and each of the hollow spaces comprises an inner face that is arched in a concave manner and corresponds to the surface that is arched in a convex manner, such that the respective webs have an essentially constant radial thickness in the circumferential direction.

14. The rotor according to claim 10, wherein the magnetic flux blocking sections are magnetically insulating.

15. The rotor according to claim 10, wherein the magnetic flux blocking sections are formed as cavities that extend in at least one of the respective webs at least in part in an axial manner through the rotor iron core.

16. The rotor according to claim 15, wherein the cavities are filled with a support material so as to increase a mechanical stability of the rotor iron core.

17. A permanently excited machine comprising:
a stator; and
a rotor that is mounted in such a manner as to be rotatable with respect to the stator, wherein:
an air gap is formed between the rotor and the stator, and
the rotor comprises:
at least two rotor poles that are arranged adjacent to one another in a circumferential direction;
a rotor iron core comprising for each rotor pole, at least one hollow space that extends in an axial manner through the rotor iron core, wherein respective webs that extend in the circumferential direction are formed in a radial direction between the at least one hollow space and an outer face of the rotor iron core; and
a permanent magnet arrangement that is embedded in the rotor iron core so as to generate an air gap magnetic flux density in an air gap of the electric machine, the air gap being adjacent to the outer face of the rotor iron core, wherein:
the permanent magnet arrangement comprises, for each rotor pole, at least one permanent magnet that is arranged in a respective hollow space,
so as to influence a progression of an air gap magnetic flux density, magnetic flux blocking sections and magnetic flux conducting sections are arranged in an alternating manner along the circumferential direction in at least one web of each rotor pole,
the magnetic flux conducting sections are formed by rotor iron core regions, and
the magnetic flux blocking sections are configured so as to conduct a magnetic flux of an associated permanent magnet within a respective adjacent magnetic flux conducting section and comprise different geometries along the circumferential direction starting from a rotor pole middle to rotor pole edges.

18. A motor vehicle comprising a permanently excited electric machine according to claim 17.
